(19) United States
(12) Patent Application Publication
(10) Pub. No.: US 2018/0334985 A1
(43) Pub. Date: Nov. 22, 2018

(54) METHOD AND SYSTEM FOR DETERMINING PRESSURE IN A FUEL ACCUMULATOR TANK OF AN ENGINE

(71) Applicant: Scania CV AB, Södertälje (SE)

(72) Inventors: Ola STENLÅÅSöä, Södertälje (SE); Erik RUNDQVIST, Stockholm (SE); Domenico CRESCENZO, Södertälje (SE)

(73) Assignee: Scania CV AB, Södertälje (SE)

(21) Appl. No.: 15/776,715

(22) PCT Filed: Nov. 28, 2016
(86) PCT No.: PCT/SE2016/051173

§ 371 Date: May 16, 2018

(30) Foreign Application Priority Data
Nov. 27, 2015 (SE) 1551538-0

(51) Int. Cl. F02D 41/40; F02B 75/18; F02M 63/02

(52) U.S. Cl. CPC F02D 41/402; F02B 75/18; F02D 2250/04; F02B 2075/1824; F02D 2200/0602; F02M 63/0225

(57) ABSTRACT

Method, system, and computer program product are provided for determining pressure in a fuel accumulator tank of a multi cylinder internal combustion engine during operation. Pressurized fuel is distributed from said accumulator tank to the cylinders by fuel injectors. A pump unit provides pressurized fuel to said accumulator tank by pump actions comprising pump strokes. The method comprises: performing pressure sampling of pressure in the fuel accumulator tank based upon a relationship between the number of pump strokes and a number of injections per crank shaft revolution such that pressure sampling occurs in connection to a fuel injection where the mutual relationship between that fuel injection and the pump action reoccurs at the fuel injection for which a pressure is to be determined; and determining a pressure in the fuel accumulator tank based upon the pressure sampling in connection to at least one earlier fuel injection, for controlling fuel injection to an individual cylinder.

### CROSS-REFERENCE TO RELATED APPLICATION(S)

This application is a National Stage Application (filed under 35 § U.S.C. 371) of PCT/SE2016/051173, filed Nov. 28, 2016 of the same title, which, in turn claims priority to Swedish Application No. 1551538-0 filed Nov. 27, 2015 of the same title; the contents of each of which are hereby incorporated by reference.

### FIELD OF THE INVENTION

The invention relates to a method, system, vehicle and computer program product for determining pressure in a fuel accumulator tank of a multi cylinder internal combustion engine during engine operation.

### BACKGROUND OF THE INVENTION

In order to introduce fuel into the cylinders of a multi cylinder internal combustion engine a common rail fuel system may be used. Such a common rail fuel system utilizes a pump unit for providing pressurized fuel to an accumulator tank from which pressurized fuel is intended to be distributed to the cylinders by means of fuel injectors. The accumulator tank comprises a common manifold generally known as a common rail. In order to control fuel injection, i.e. amount of fuel to be injected and fuel injection timing, the pressure in the fuel accumulator tank needs to be determined prior to the injection.

GB2512920 discloses a method for controlling a fuel injector for an internal combustion engine where the pressure for which fuel injection is based according to an embodiment is the average pressure of the last interval sample taken before start of the injection event and after end of the injection event.

U.S. Pat. No. 6,085,727 discloses a method for determining rail pressure for controlling the amount of fuel wherein the rail pressure is determined by pressure sampling from last injection or average of several injections, this being used as basis for the current injection.

There is however a need for improving determination of pressure in a fuel accumulation tank in order to obtain a more accurate control of fuel injection.

### SUMMARY OF THE INVENTION

An object of the present invention is to provide a method for determining pressure in a fuel accumulator tank of a multi cylinder internal combustion engine during engine operation so as to facilitate more accurate control of fuel injection to an individual cylinder.

Another object of the present invention is to provide a system for determining pressure in a fuel accumulator tank of a multi cylinder internal combustion engine during engine operation so as to facilitate more accurate control of fuel injection to an individual cylinder.

These and other objects, apparent from the following description, are achieved by a method, a system, a vehicle, a computer program and a computer program product, as set out in the appended independent claims. Preferred embodiments of the method and the system are defined in appended dependent claims.

Specifically an object of the invention is achieved by a method for determining pressure in a fuel accumulator tank of a multi cylinder internal combustion engine during engine operation. Pressurized fuel is intended to be distributed from said accumulator tank to the cylinders by means of fuel injectors so as to rotate a crankshaft of the engine. A pump unit is provided for providing pressurized fuel to said accumulator tank by means of pump actions comprising pump strokes. The method comprises the step of determining the pressure in the fuel accumulator tank based upon a pressure sampling in connection to at least one earlier fuel injection as a basis for controlling fuel injection to an individual cylinder. The method further comprises the step of performing said pressure sampling based upon the relationship between the number of pump strokes and the number of injections per crank shaft revolution such that said pressure sampling occurs in connection to a fuel injection where the mutual relationship between that fuel injection and the pump action reoccurs at the fuel injection for which the determined pressure is intended to form a basis.

Thus the repetitive behavior of the relationship of the number of pump strokes and number of fuel injections is used for the pressure sampling so as to provide a more accurate pressure to be used as a basis for the fuel injection, i.e. as a basis for the amount of fuel to be injected and the on-time for the injector from which fuel is intended to be injected into an individual cylinder for combustion.

Thus, said pressure sampling is performed such that said pressure sampling occurs in connection to a fuel injection so that both the number of pump strokes and the number of fuel injections from the sampling to the fuel injection for which the determined pressure is intended to form a basis correspond to an integer value. For a six cylinder engine providing four pump strokes and three fuel injections per crankshaft revolution an integer value of both pump strokes and fuel injections occurs every crank shaft revolution, and although this pressure sampling not being the latest possible sample data, it will provide a more accurate result than a pressure sampling performed in connection to e.g. the injection immediately before the injection for which the determined pressure is intended to form a basis, i.e. one third of a revolution. Furthermore the invention facilitates avoiding the problem of the fact that the average of the pressure sampling is repeatedly determined by means of an electronic control unit on a regular time basis, e.g. every 10 ms, which may occur on different times relative to injections and which thus may result in data acquired immediately before the injection for which the determined pressure is intended to form a basis not being calculated.

By thus performing the pressure sampling during steady state operation of the engine based upon said relationship between the number of pump strokes and the number of injections per crank shaft revolution the pressure sampling occurs in connection to an earlier fuel injection where the behavior of the pressure in the fuel accumulator tank is expected to essentially reoccur at the fuel injection for which the determined pressure is intended to form a basis. Fuel injection and pump stroke/pump action are related to the engine speed so that the pressure behavior at that fuel injection when the relationship between pump stroke and fuel injection is repeated will be essentially the same during steady state operation.

Thus, the fact the pressure behavior shows a pattern that is repeated based upon the relationship of number of pump strokes and number of fuel injections during rotation of the crankshaft, facilitates providing a result of the pressure from such pressure sampling that will to a very accurate extent be repeated in connection to the injection for which the pressure is predicted. This thus facilitates improved control of engine operation, comprising more efficient engine operation, reduced emissions, decreased losses and the like.

For steady state engine operation and low speeds where losses and low engine operation efficiency due to inaccuracy relating to fuel injection becomes more apparent the invention is particularly useful in that it, by more accurately predicting the pressure in the accumulator tank/common rail, facilitates more accurate fuel injection with regard to amount of fuel and on-time for fuel injection, which results in improved engine efficiency and reduction in losses.

By thus performing the pressure sampling based upon said relationship between the number of pump strokes and the number of injections per crank shaft revolution so that sampling is performed in connection to a fuel injection with a relationship of fuel injection and pump stroke/pump action that is repeated at the fuel injection for which the determined pressure is intended to form a basis an accurate determination will be obtained independently of the relationship of the number of pump strokes and number of fuel injections per crankshaft operation and independently of if there is no synchronization between the pump strokes and the fuel injections, which is common, or whether they are synchronized, and independently of how the pump unit is operated, i.e. independently of whether the pump unit is operated by means of the engine/crankshaft/camshaft operation or electrically operated.

As the pressure behavior is repeated possible errors would also be repeated and from a control system perspective it is easier to control and adjust an error that is repeating than an error which shows a stochastic behavior. By thus basing the pressure sampling on the relationship between the number of pump strokes and number of injections per crankshaft revolution such that the reoccurrence of the relationship and thus behavior is used the error in determining the pressure is reduced, but furthermore the possible error is moved from a stochastic behavior to behaving in the same way. Thus, the invention also improves the possibility of compensating for possible errors.

If the respective fuel injection to an individual cylinder during engine operation is a fuel injection event in a multiple injection strategy for fuel injection into an individual cylinder pressure sampling may be performed in connection to one or more of the multiple injections to an individual cylinder. Thus, when a fuel injection in connection to which pressure sampling is performed is a fuel injection event in a multiple injection strategy for fuel injection into an individual cylinder involving pilot injection, main injection and post injection, pressure sampling may be performed in connection to the pilot injection and/or the main injection and/or the post injection.

When a fuel injection in connection to which pressure sampling is performed is a fuel injection event in a multiple injection strategy for fuel injection into an individual cylinder involving pilot injection, main injection and post injection the pressure behavior will reoccur where the mutual relationship between that fuel injection and the pump action reoccurs for each of the pilot injection, main injection and post injection.

According to an embodiment of the method the step of performing said pressure sampling further comprises the step of performing said pressure sampling such that said pressure sampling occurs in connection to a fuel injection where the fuel injection with that same fuel injector reoccurs at the fuel injection for which the determined pressure is intended to form a basis.

By in addition to utilizing the reoccurrence of the behavior of the pump stroke/pump action in connection to the fuel injections where pressure sampling is performed, performing the fuel sampling in connection to the fuel injection of the same injector, an even more accurate determination of the pressure in the accumulator tank may be facilitated during a steady state engine operation. This is due to the fact that each injector has its own tolerances and therefore may cause a slight difference in the pressure behavior, whereas the same injector will provide the same behavior. Thus, even if the result of a pressure sampling using the same injector is based on older data, it may during a steady state engine operation provide a more accurate determination of the pressure forming a basis for the upcoming fuel injection. According to an embodiment sampling may be performed such that both data for pressure sampling in connection to the same injector with reoccurrence of the pump action behavior and newer data for pressure sampling with reoccurrence of the pump action behavior are used as a basis the fuel injection. For a six cylinder engine providing four pump strokes and three fuel injections per crankshaft revolution the same injector reoccurs every second crankshaft revolution.

According to an embodiment of the method, for a six cylinder engine providing four pump strokes and three fuel injections per crankshaft revolution, the pressure sampling is performed such that said pressure sampling occurs in connection to a fuel injection one revolution and/or two revolutions before the fuel injection for which the determined pressure is intended to form a basis.

For a 5-cylinder engine with five injections and eight strokes during two crankshaft revolutions the pressure sampling is performed such that said pressure sampling occurs in connection to a fuel injection two revolutions, i.e. 720 crankshaft degrees, before the fuel injection for which the determined pressure is intended to form a basis.

For an 8-cylinder engine with four injections and four pump strokes per crankshaft revolution the pressure sampling is performed such that said pressure sampling occurs in connection to a fuel injection eight of a revolution, i.e. 45 crankshaft degrees, before the fuel injection for which the determined pressure is intended to form a basis, i.e. repetition of pressure behavior every fuel injection.

According to an embodiment of the method the step of performing pressure sampling in connection to a fuel injection comprises performing pressure sampling before start of injection and after end of injection, wherein the number of samples are chosen with regard to the fluid hammer due to an end of injection. Preferably pressure sampling is performed before the start of the fuel injection and after the end of the fuel injection.

When a fuel injection in connection to which pressure sampling is performed is a fuel injection event in a multiple injection strategy for fuel injection into an individual cylinder involving pilot injection, main injection and post injection, pressure sampling is performed such that if pressure sampling is performed in connection to the pilot injection it is performed before start of pilot injection and after end of pilot injection, if pressure sampling is performed in connection to the main injection it is performed before start of main injection and after end of main injection, and if pressure sampling is performed in connection to the post injection it is performed before start of post injection and after end of post injection.

By performing pressure sampling before the start of the fuel injection and after the end of the fuel injection a good basis for determining the pressure by means of taking the average of the samples of said pressure sampling is obtained. An average value of the samples of the pressure sampling before start of fuel injection is calculated and another average value of the samples of the pressure sampling after end of fuel injection is calculated. More specifically a good basis for determining the average pressure from start of injection to end of injection by means of taking the average of the samples of said pressure sampling is facilitated. As mentioned below the start of injection and end of injection are according to an embodiment the mechanical/hydraulic start of injection and end of injection. The start of injection and end of injection could also be the electrical start of injection and end of injection. By choosing the number of samples of the pressure sampling with regard to the fluid hammer, i.e. the wave of the fuel caused by opening and closing the valves of the fuel injector for starting and ending the fuel injection, the oscillations of the period of the fluid hammer can be cancelled out by taking the average of those samples. Thus, samples corresponding to the period of the fluid hammer are chosen. The oscillation period depends on the accumulator geometry, in particular the length of the fluid column where the wave propagates, and the speed of sound in the medium depending on accumulator pressure, i.e. rail pressure, and fuel properties. The number of samples is according to an embodiment in the range of 1-50, e.g. 3-30, samples before start of injection and in the range of 1-50, e.g. 3-30 samples after end of injection The number of samples is according to an embodiment for a certain fuel injection system 24 samples before start of injection and 24 samples after end of injection, which is e.g. applicable to a six cylinder engine providing three injections and four pump strokes per crankshaft revolution. Sampling in this way is chosen as it is assumed that the fluid hammer measured at the location of the pressure sensor unit is different from what is actually happening in connection to the injector. Therefore, the effect of the fluid hammer is eliminated by averaging it. Ideally, this average should well represent the average pressure at the injector.

According to an embodiment of the method start of injection before which pressure sampling is performed is the mechanical start of injection and wherein end of injection after which pressure sampling is performed is the mechanical end of injection. By thus basing the pressure sampling on the mechanical, e.g. hydraulic, start/end of injection instead of the electrical start/end of injection a more accurate pressure sampling is obtained as the mechanical start and end of injection may be accurately predicted which facilitates determining a more accurate average pressure during injection by sampling of the pressure immediately before mechanical start of injection and immediately after start of injection. By thus basing the pressure sampling on the mechanical, e.g. hydraulic, start/end of injection instead of the electrical start/end of injection the physics of the pressure behavior is better captured and the average of the pressure samples should better represent the actual mean accumulator pressure, i.e. rail pressure, during injection.

According to an embodiment of the method the step of performing pressure sampling based upon the relationship between the number of pump strokes and the number of injections per crank shaft revolution is performed under steady state operation, the method further comprising the step of changing the performance of pressure sampling such that pressure sampling is performed at the fuel injection or fuel injections closest to the fuel injection for which the determined pressure is intended to form a basis if the engine operation changes from steady state operation to operation involving rapid changes of pressure in the fuel accumulator tank. Thus, when changed to non-steady state engine operation pressure sampling is based on early data which may be pressure sampling in connection to the fuel injection closest to the fuel injection for which the determined pressure is intended or pressure sampling in connection to the two closest fuel injections or more than two closest fuel injections, where the average of the pressure data from the pressure samplings may be used. Hereby the pressure sampling is controlled in an efficient way such that the determined pressure is the most accurate possible both during steady state engine operation and engine operation involving engine speed changes.

A system for determining pressure in a fuel accumulator tank of a multi cylinder internal combustion engine during engine operation, pressurized fuel being intended to be distributed from said accumulator tank to the cylinders by means of fuel injectors so as to rotate a crankshaft of the engine, a pump unit being provided for providing pressurized fuel to said accumulator tank by means of pump actions comprising pump strokes, the system comprising means for determining the pressure in the fuel accumulator tank based upon a pressure sampling in connection to at least one earlier fuel injection as a basis for controlling fuel injection to an individual cylinder, characterized by means for performing said pressure sampling based upon the relationship between the number of pump strokes and the number of injections per crank shaft revolution such that said pressure sampling occurs in connection to a fuel injection where the mutual relationship between that fuel injection and the pump action reoccurs at the fuel injection for which the determined pressure is intended to form a basis.

According to an embodiment of the system the means for performing said pressure sampling further comprises means for performing said pressure sampling such that said pressure sampling occurs in connection to a fuel injection where the fuel injection with that same fuel injector reoccurs at the fuel injection for which the determined pressure is intended to form a basis.

According to an embodiment of the system, for a six cylinder engine providing four pump strokes and three fuel injections per crankshaft revolution, said pressure sampling is arranged to be performed such that said pressure sampling occurs in connection to a fuel injection one revolution and/or two revolutions before the fuel injection for which the determined pressure is intended to form a basis.

According to an embodiment of the system the means for performing pressure sampling in connection to a fuel injection comprises means for performing pressure sampling before start of injection and after end of injection, wherein the number of samples are chosen with regard to the fluid hammer due to and end of injection.

According to an embodiment of the system start of injection before which pressure sampling is arranged to be performed is the mechanical start of injection and wherein end of injection after which pressure sampling is arranged to be performed is the mechanical end of injection.

According to an embodiment the system comprises means for determining engine operation status, wherein the means for performing pressure sampling based upon the relationship between the number of pump strokes and the number of injections per crank shaft revolution is arranged to be performed under steady state engine operation, the system further comprising means for changing the performance of pressure sampling such that pressure sampling is performed at the fuel injection closest to the fuel injection or fuel injections for which the determined pressure is intended to form a basis if the engine operation changes from steady state engine operation to operation involving rapid changes of pressure in the fuel accumulator tank.

The system for determining pressure in a fuel accumulator tank of a multi cylinder internal combustion engine during engine operation is adapted to perform the methods as set out herein.

The system according to the invention has the advantages according to the corresponding method claims.

Specifically an object of the invention is achieved by a vehicle comprising a system according to the invention as set out herein.

Specifically an object of the invention is achieved by a computer program for determining pressure in a fuel accumulator tank of a multi cylinder internal combustion engine during engine operation, said computer program comprising program code which, when run on an electronic control unit or another computer connected to the electronic control unit, causes the electronic control unit to perform the method according to the invention.

Specifically an object of the invention is achieved by a computer program product comprising a digital storage medium storing the computer program.

### BRIEF DESCRIPTION OF THE DRAWINGS

For a better understanding of the present invention reference is made to the following detailed description when read in conjunction with the accompanying drawings, wherein like reference characters refer to like parts throughout the several views, and in which:

FIG. 1 schematically illustrates a side view of a vehicle according to an embodiment of the present invention;

FIG. 2 schematically illustrates a system for determining pressure in a fuel accumulator tank of a multi cylinder internal combustion engine during engine operation according to an embodiment of the present invention;

FIG. 3 schematically illustrates the pressure behavior in a fuel accumulator tank during engine operation involving fuel injections and pump strokes according to an embodiment of the present invention;

FIG. 4 schematically illustrates the pressure behavior in a fuel accumulator tank during engine operation in relation to crankshaft revolutions according to an embodiment of the present invention;

FIG. 5 schematically illustrates pressure sampling strategy according to an embodiment of the present invention;

FIG. 6 schematically illustrates a method for determining pressure in a fuel accumulator tank of a multi cylinder internal combustion engine during engine operation according to an embodiment of the present invention; and

FIG. 7 schematically illustrates a computer according to an embodiment of the present invention.

### DETAILED DESCRIPTION OF THE INVENTION

Hereinafter the term “link” refers to a communication link which may be a physical connector, such as an optoelectronic communication wire, or a non-physical connector such as a wireless connection, for example a radio or microwave link.

Hereinafter the term “pressure sampling” refers to determination of pressure by means of taking a set of samples, the samples being taken by means of one or more sensor units configured to detect the pressure in a fuel accumulator tank, e.g. a common rail. Pressure sampling is according to an embodiment performed by means of a rail pressure sensor. The term “pressure sampling” according to an embodiment refers to a set of samples being taken at a certain sampling frequency.

Hereinafter the term “pump stroke” refers to the actual strokes provided by a pump unit during operation of the pump unit for providing pressurized fuel to an accumulator tank during engine operation.

Hereinafter the term “pump action” refers to the operation of a pump unit providing pressurized fuel to an accumulator tank during engine operation, the pump action involving pump strokes.

Hereinafter the term “fuel injection” refers to “a general fuel injection event in a single or multiple injection strategy during a piston stroke for injection of fuel into an individual cylinder. The term “fuel injection” refers to main injection and, when present, also to pilot injection/injections and post injection/injections. The term “fuel injection” thus comprises a fuel injection event in a single injection strategy where fuel is injected one time as a main injection during a piston stroke into an individual cylinder, the single injection event strategy involving one start of injection and one end of injection. The term “fuel injection” thus comprises a fuel injection event in a multiple injection strategy where fuel is injected more than one time during a piston stroke into an individual cylinder, the multiple injection event strategy according to an embodiment involving one or more pilot injections, main injection, and/or one or more post injections, where each of the pilot, main and post injections involve a start of injection and an end of injection.

Hereinafter the term “Pilot injection” refers to an initial injection to enhance turbulence in the combustion chamber and also for several other reasons.

Hereinafter the term “Main injection” refers to the injection where most part of the fuel is injected.

Hereinafter the term “Post injection” refers to an injection which takes place in order to enhance the oxidation of the non-fully oxidized species and reduce the emissions and/or to support the exhaust treatment system with temperature and/or unburned hydrocarbons/CO.

Hereinafter the term “electrical start of injection” refers to electrical signal from electronic control unit for opening injector.

Hereinafter the term “start of injection delay” refers to delay from electrical opening signal until injector actually opens and fuel starts to flow into the cylinder.

Hereinafter the term “mechanical start of injection” refers the start of hydraulic injection, i.e. fuel starts to flow into the cylinder. May refer to open position of the valve of the injector.

Hereinafter the term “electrical end of injection” refers to electrical signal from electronic control unit for closing injector.

Hereinafter the term “end of injection delay” refers to delay from electrical closing signal until injector actually closes and fuel stops flowing into the cylinder.

Hereinafter the term “mechanical end of injection” refers the end of hydraulic injection, i.e. fuel stops to flow into the cylinder. May refer to closed position of the valve of the injector.

Hereinafter the term “on-time” refers to the time the injector is commanded to be open, the time between electrical start of injection and electrical end of injection.

Hereinafter the term “engine operation status” refers to whether the engine operation is steady, i.e. is operating under stationary conditions, with essentially no variations in engine speed and engine load/torque demand, or whether the engine operation is non-steady, i.e. is operating under transient conditions, with variations in engine speed and/or engine load.

Hereinafter the term “fluid hammer” refers to a pressure surge or wave caused when a fluid in the form of the injected fuel in motion is forced to stop or change direction suddenly, here by closure of valve in connection to end of injection. “Fluid hammer” is often called “water hammer”. A fluid hammer occurs when a valve in the injector closes suddenly, and a pressure wave propagates in the pipe. It is also called hydraulic shock.

Hereinafter the term “means for” e.g. in relation to “means for determining the pressure in the fuel accumulator tank”, “means for performing pressure sampling”, “means determining engine operation status” and “means for changing the performance of pressure sampling” refers to “means adapted for”.

The engine according to the present invention could be any suitable internal combustion engine with any suitable number of cylinders with any suitable number of injections and any suitable number of pump strokes per crankshaft revolution. The internal combustion engine according to the present invention could for example be a 5-cylinder engine, a 6-cylinder engine or an 8-cylinder engine. The cylinders could be in any suitable alignment, for example inline engine or a V-engine.

The invention is thus applicable to any multicylinder internal combustion engine with any known number of cylinders/injectors. The invention is thus applicable to any fuel injection system providing any suitable number of injections per crankshaft revolution and any suitable number of pump strokes per crankshaft revolution during engine operation.

It could for example be a 5-cylinder engine with five injections and four eight strokes during two crankshaft revolutions, 6-cylinder engine with three injections and four pump strokes per crankshaft revolution, an 8-cylinder engine with four injections and four pump strokes per crankshaft revolution or the like.

Below in connection to FIGS. 2-5 an embodiment for a 6-cylinder engine with three injections and four pump strokes per crankshaft revolution is described.

The invention is applicable to two stroke engines, four stroke engines, six stroke engines and eight stroke engines.

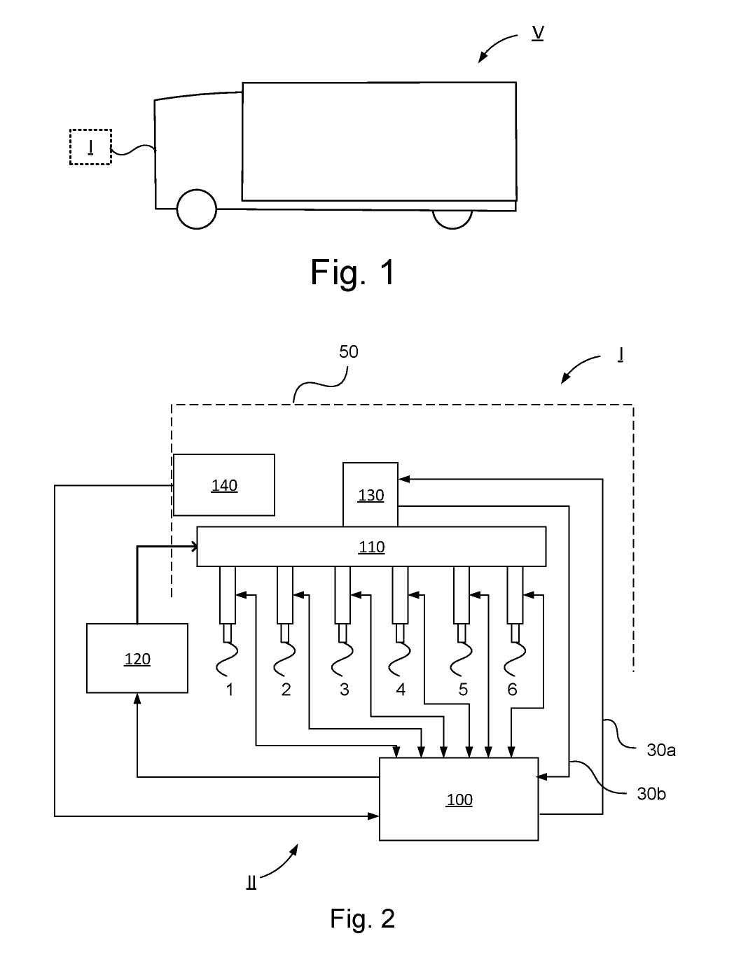

FIG. 1 schematically illustrates a side view of a vehicle V according to the present invention. The exemplified vehicle V is a heavy vehicle in the shape of a truck. The vehicle according to the present invention could be any suitable vehicle such as a bus or a car.

The vehicle 1 comprises a system I for determining pressure in a fuel accumulator tank of a multi cylinder internal combustion engine during engine operation. The thus determined pressure is intended to form a basis for controlling fuel injection to an individual cylinder.

FIG. 2 schematically illustrates a system I for determining pressure in a fuel accumulator tank 110 of a multi cylinder internal combustion engine 50 during engine operation according to an embodiment of the present invention.

The system I is comprised in a fuel injection system II which may be used in any vehicle comprising any ground vehicle such as a truck or lorry. The system I could according to an embodiment constitute the system II. The system I and thus the fuel injection system II may be used in a water craft or underwater craft, e.g. a ship or submarine. The system I may be used which is or is comprised in a fuel injection system which may be used in a power plant.

The system I is applicable to any suitable internal combustion engine with any suitable number of cylinders and any suitable number of injections per crankshaft revolution and any suitable number of pump strokes per crankshaft revolution.

The system I is intended to perform a method according to the present invention.

The system I comprises an electronic control unit 100. The electronic control unit 100 is arranged to control the fuel injection in the fuel injection system.

A pump unit 120 is provided for providing pressurized fuel to said accumulator tank 110 by means of pump actions comprising pump strokes. The thus pressurized fuel is intended to be distributed from said accumulator tank 110 to the cylinders by means of fuel injectors 1, 2, 3, 4, 5, 6 so as to rotate a crankshaft of the engine 50.

The multi cylinder internal combustion engine 50 is according to an embodiment a diesel engine. The internal combustion engine 50 according to this embodiment is a six cylinder engine with six fuel injectors 1-6, one for each cylinder. The fuel injectors 1-6 are according to an embodiment electronic fuel injectors. The engine is configured to provide tree injections and four pump strokes per crankshaft revolution.

The fuel injection system II comprises the accumulator tank 110 arranged to receive pressurized fuel from the pump unit 140. The fuel injection system II comprises the electronic control unit 100. The fuel injection system II comprises the fuel injectors 1-6. The electronic control unit 100 is arranged to control the fuel injection system II.

The pump unit 120 is a high pressure pump unit 120 being adapted to pressurize the fuel so that it enters at high pressure in the accumulator tank 110 which takes the form of a so-called Common Rail. The high fuel pressure in the accumulator tank 110 constitutes a power source making it possible for fuel to be injected at high pressure into the respective cylinders of the engine 50. The fuel in the accumulator tank 110 is intended to be distributed to all the cylinders of the engine 50 via the injectors 1-6.

The system I comprises means 130 for determining the pressure in the fuel accumulator tank 110 based upon a pressure sampling in connection to at least one earlier fuel injection as a basis for controlling fuel injection to an individual cylinder. The means 130 for determining the pressure in the fuel accumulator tank 110 comprises one or more sensor units configured to detect the pressure in a fuel accumulator tank 110, e.g. a common rail. The means 130 for determining the pressure in the fuel accumulator tank 110 comprises according to an embodiment a rail pressure sensor arranged to perform pressure sampling by means of repeatedly detecting the pressure in the tank 110 so as to obtain a set of pressure samples. The set of samples are obtained by the means 130 at a certain sampling frequency.

The system I comprises means for performing said pressure sampling based upon the relationship between the number of pump strokes and the number of injections per crank shaft revolution such that said pressure sampling occurs in connection to a fuel injection where the mutual relationship between that fuel injection and the pump action reoccurs at the fuel injection for which the determined pressure is intended to form a basis. The means for performing said pressure sampling based upon the relationship between the number of pump strokes and the number of injections per crank shaft revolution comprises the electronic control unit 100 and the means 130 for determining the pressure in the accumulator tank 110.

The electronic control unit 100 is arranged to control the operation of the fuel injectors 1-6. The electronic control unit 100 is operably connected to the fuel injectors 1-6 via links. The electronic control unit 100 is via the links arranged to send signals to the injectors representing data for controlling the respective injector 1-6 comprising data for controlling the on-time of the respective injector.

The electronic control unit 100 is according to an embodiment via links arranged to send electrical signals representing data for opening injector to the respective injector.

The electronic control unit 100 is according to an embodiment via links arranged to send electrical signals representing data for closing injector to the respective injector.

The electronic control unit 100 is according to an embodiment via links arranged to receive signals from the injectors representing data for status of the respective injector comprising data for the mechanical start of injection, i.e. start of hydraulic injection and the mechanical end of injection of the respective fuel injector, i.e. end of hydraulic injection. The data for mechanical start and end of injection for the respective injector comprises data for position of valve of the respective injector, i.e. open valve or closed valve.

The electronic control unit 100 is according to an embodiment via links arranged to receive signals representing data for delay from electrical opening signal until injector actually opens.

The electronic control unit 100 is according to an embodiment via links arranged to receive signals representing data for delay from electrical closing signal until injector actually closes.

The electronic control unit 100 is arranged to control the operation of the pump unit 120. The electronic control unit 100 is operably connected to the pump unit 120 via a link. The electronic control unit 100 is via the link arranged to send signals to the pump unit 120 representing data for controlling provision of pressurized fuel to the accumulator tank 110. The pressurized fuel is provided to the fuel accumulator tank 110 via a fuel pipe.

The electronic control unit 100 is arranged to control the operation of the means 130 for determining the pressure in the fuel accumulator tank 110. The electronic control unit 100 is operably connected to the means 130 for determining the pressure in the fuel accumulator tank 110 via a link 30a. The electronic control unit 100 is via the link 30a arranged to send signals to the means 130 representing data for controlling pressure sampling of the pressure in the accumulator tank 110. The data for controlling pressure sampling of the pressure in the accumulator tank 110 comprises data for controlling the pressure sampling so that it is performed before the mechanical start of injection and after mechanical end of injection.

The electronic control unit 100 is operably connected to the means 130 for determining the pressure in the fuel accumulator tank 110 via a link. The electronic control unit 100 is via the link arranged to send signals to the means 130 representing data for controlling pressure sampling of the pressure in the accumulator tank 110.

The data for controlling pressure sampling of the pressure in the accumulator tank 110 comprises data for controlling the number of samples so that the number of samples are chosen with regard to the fluid hammer due to and end of injection.

The data for controlling pressure sampling of the pressure in the accumulator tank 110 comprises data for controlling the performance such that such that said pressure sampling occurs in connection to a fuel injection on revolution and/or two revolutions before the fuel injection for which the determined pressure is intended to form a basis.

Generally for the system I the data for controlling pressure sampling of the pressure in the accumulator tank 110 comprises data for controlling the performance such that such that said pressure sampling occurs in connection to a fuel injection where the mutual relationship between that fuel injection and the pump action reoccurs at the fuel injection for which the determined pressure is intended to form a basis.

The electronic control unit 100 is operably connected to the means 130 for determining the pressure in the fuel accumulator tank 110 via a link 30b. The electronic control unit 100 is via the link 30b arranged to receive signals from the means 130 representing pressure data for determined pressure in the accumulator tank 110.

The electronic control unit 100 is arranged to control the operation of the fuel injectors 1-6 based on the thus determined pressure in the accumulator tank 110. The electronic control unit 100 is operably connected to the fuel injectors 1-6 via links. The electronic control unit 100 is via the respective link arranged to send signals to the injector for which said determined pressure is intended representing data for controlling the injector based upon the pressure determined by means of the means 130 comprising data for controlling the on-time of the respective injector and the amount of fuel. The fuel injectors 1-6 are arranged, respectively, to inject fuel from the accumulator tank into the combustion space of a corresponding cylinder (not shown).

To control the injection of fuel an injection means in the form of electronic fuel injectors 1-6 is arranged in each of the connections between the accumulator tank 110 and the respective cylinders of the engine. When a fuel injector is in an open state, it injects fuel at high pressure into the cylinder concerned. Thus, fuel from the accumulator tank 110 is injected into the combustion spaces of the respective cylinder by means of the fuel injectors 1-6, which fuel injectors 1-6 are configured to open and close very quickly in a controlled manner.

The system I comprises means for controlling the pressure sampling based upon the status of the engine operation.

The system I comprises means 140 for determining status of engine operation. The means for determining status engine operation comprises means for determining engine speed and possible changes in engine speed. The means for determining engine speed comprises according to an embodiment one or more speed sensor units. The means for determining status engine operation comprises means for determining engine load and possible changes in engine load. The means for determining engine load comprises according to an embodiment one or more load sensor units. The engine load may correspond to the demanded torque. The load may also be expressed as an indicated load, i.e. IMEP (Indicated Mean Effective Pressure) or demanded IMEP, or as a fraction of the torque or IMEP.

The electronic control unit 100 is operably connected to the means 140 for determining status of engine operation via a link. The electronic control unit 100 is via the link arranged to receive signals from the means 140 representing data for engine status.

The electronic control unit 100 is arranged to control the means 130 for determining the pressure in the accumulator tank 110 by means of pressure sampling based upon the status of engine operation.

The electronic control unit 100 is arranged to control the means 130 for determining pressure in the accumulator tank 110 such that pressure sampling performance based upon the relationship between the number of pump strokes and the number of injections per crank shaft revolution, here pressure sampling every crankshaft revolution, is performed under steady state engine operation.

The electronic control unit 100 is arranged to control the means 130 for determining pressure in the accumulator tank 110 such that pressure sampling is performed at the fuel injection closest to the fuel injection for which the determined pressure is intended to form a basis if the engine operation involves rapid changes of pressure in the fuel accumulator tank, i.e. is not in steady state operation.

The electronic control unit 100 is arranged to control the means 130 for determining pressure in the accumulator tank 110 such that performance of pressure sampling from pressure sampling performance based upon the relationship between the number of pump strokes and the number of injections per crank shaft revolution to pressure sampling based on fuel injection closest to the fuel injection for which the determined pressure is intended to form a basis, if the engine operation changes from steady state engine operation to operation involving rapid changes of pressure in the fuel accumulator tank and vice versa.

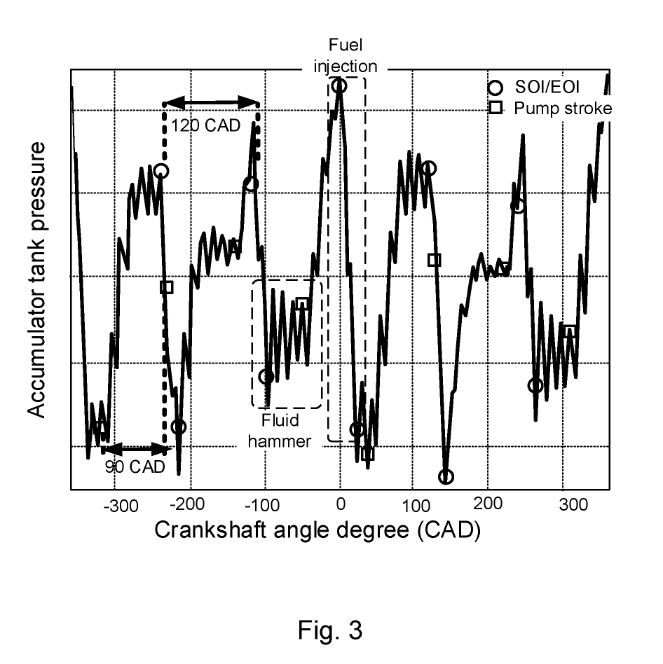

FIG. 3 schematically illustrates the pressure behavior in a fuel accumulator tank during engine operation involving fuel injections and pump strokes according to an embodiment of the present invention. The example is for steady state engine operation with an engine speed of 1200 rpm and full load.

This is thus for an internal combustion engine with six cylinders and three injections and four pump strokes per crankshaft revolution, where there is no synchronization with regard to crankshaft angle degree (CAD) between the fuel injections and the pump strokes. Two crankshaft revolutions, i.e. 720 CAD, are illustrated in FIG. 3.

As can be seen in FIG. 3 the pump strokes occur approximately every 90 CAD during rotation of the crankshaft and the fuel injection occur every 120 CAD.

Furthermore the mechanical start of injection (SOI) and the mechanical end of mechanical injection (EOI) are illustrated. According to an embodiment of the invention pressure sampling is performed before mechanical start of injection and after the mechanical end of injection. By thus basing the pressure sampling on the mechanical, e.g. hydraulic, start/end of injection instead of the electrical start/end of injection a more accurate pressure sampling is obtained as the mechanical start and end of injection may be accurately predicted.

After end of the injection, i.e. after the sudden closure of the valve of the injector, a fluid hammer occurs which is illustrated in FIG. 3. Thus, at the end of mechanical injection the flow is abruptly interrupted and the fluid hammer propagates. According to an embodiment of the invention the number of samples during pressure sampling before SOI and after EOI are chosen with regard to the fluid hammer due to and end of injection. Although fluid hammer mainly is due to closing of valve at end of injection, in most cases the next start of injection will take place before the fluid hammer decades. By choosing the number of samples of the pressure sampling with regard to the fluid hammer, i.e. the wave of the fuel caused by opening and closing the valves of the fuel injector for starting and ending the fuel injection, the oscillations of the period of the fluid hammer can be cancelled out by taking the average of those samples. Thus, samples corresponding to the period of the fluid hammer are chosen. The oscillation period depends on the accumulator geometry, in particular the length of the fluid column where the wave propagates, and the speed of sound in the medium depending on accumulator pressure, i.e. rail pressure, and fuel properties. The number of samples is according to an embodiment in the range of 1-50, e.g. 3-30, samples before start of injection and in the range of 1-50, e.g. 3-30 samples after end of injection The number of samples is according to an embodiment for a certain fuel injection system 24 samples before start of injection and 24 samples after end of injection, which is applicable to the six cylinder engine providing three injections and four pump strokes per crankshaft revolution. Sampling in this way is chosen as it is assumed that the fluid hammer measured at the location of the pressure sensor unit is different from what is actually happening in connection to the injector. Therefore, the effect of the fluid hammer is eliminated by averaging it. Ideally, this average should well represent the average pressure at the injector.

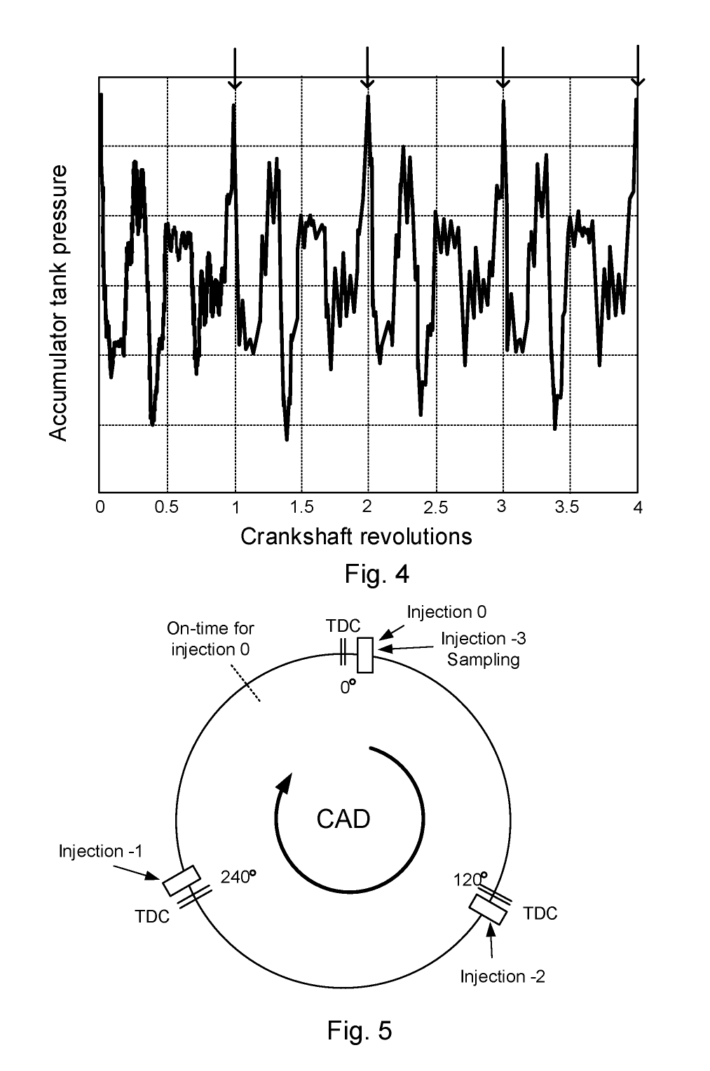

FIG. 4 schematically illustrates the pressure behavior in a fuel accumulator tank during engine operation in relation to crankshaft revolutions according to an embodiment of the present invention. The example is for steady state engine operation with an engine speed of 2000 rpm and full load.

As can be seen in FIG. 4 the behavior of the pressure in the fuel accumulator tank essentially reoccurs at every crankshaft revolution as illustrated by the arrows, i.e. pressure behavior reoccurs at first revolution 1, second revolution 2, third revolution 3 and fourth revolution 4 etc. Fuel injection and pump stroke/pump action are related to the engine speed so that the pressure behavior at that fuel injection when the relationship between pump stroke and fuel injection is repeated will be essentially the same during steady state operation. The repetition of the behavior for a six cylinder engine with three injection and four pump strokes per crankshaft revolution is every crankshaft revolution.

According to this embodiment of the invention, for the six cylinder engine providing four pump strokes per crankshaft revolution, the pressure sampling is performed such that said pressure sampling occurs in connection to a fuel injection one revolution and/or two revolutions before the fuel injection for which the determined pressure is intended to form a basis.

The invention thus relates to performing the pressure sampling based upon the relationship between the number of pump strokes and the number of injections per crank shaft revolution such that said pressure sampling occurs in connection to a fuel injection where the mutual relationship between that fuel injection and the pump action reoccurs at the fuel injection for which the determined pressure is intended to form a basis.

By in this case performing the pressure sampling every crank shaft revolution the pressure sampling occurs in connection to an earlier fuel injection where the behavior of the pressure in the fuel accumulator tank is expected to essentially reoccur at the fuel injection for which the determined pressure is intended to form a basis.

Thus the repetitive behavior of the pressure at every crankshaft revolution is used for the pressure sampling so as to provide a more accurate pressure to be used as a basis for the fuel injection, i.e. as a basis for the amount of fuel to be injected and the on-time for the injector from which fuel is intended to be injected into an individual cylinder for combustion.

Although this pressure sampling is not the latest possible sample data, it will provide a more accurate result than a pressure sampling performed in connection to e.g. the injection immediately before the injection for which the determined pressure is intended to form a basis, i.e. one third of a revolution or the two injections immediately before the injection for which the determined pressure is intended to form a basis, i.e. one third and two thirds of a revolution.

Thus, this facilitates providing a result of the pressure from such pressure sampling that will to a very accurate extent be repeated in connection to the injection for which the pressure is predicted. This thus facilitates improved control of engine operation, comprising more efficient engine operation, reduced emissions, decreased losses and the like.

As can be seen from FIG. 4 the reoccurrence of the pressure behavior is even more accurate at every second crankshaft revolution, where fuel injection with the same injector is repeated. According to an embodiment of the invention said pressure sampling is performed such that the pressure sampling occurs in connection to a fuel injection where the fuel injection with that same fuel injector reoccurs at the fuel injection for which the determined pressure is intended to form a basis, i.e. in this case every second crankshaft revolution.

By thus performing the fuel sampling in connection to the fuel injection of the same injector, an even more accurate determination of the pressure in the accumulator tank may be facilitated, due to the fact that each injector has its own tolerances and therefore may cause a slight difference in the pressure behavior, the same injector thus providing the same behavior.

FIG. 5 schematically illustrates pressure sampling strategy according to an embodiment of the present invention. The sampling strategy is for a six cylinder engine providing four pump strokes and three fuel injections per crankshaft revolution. For such a six cylinder engine the cylinder interrupt, i.e. the end of the control window in time or CAD of the injector at the cylinder aimed at, according to an embodiment is at a certain CAD before the piston of the cylinder reaches the top dead centre (TDC) for combustion, which sets the boundary for the fuel on-time for injection. It is at this point that all calculations of upcoming injection is computed. The location is arbitrary. It corresponds to how early injection should be possible, basically limiting how early a pilot injection can be executed. Thus, at some CAD before TDC the calculations, e.g. on-time/timing of injection for the upcoming injection is executed.

As explained in connection to FIG. 5 the pressure sampling is performed in connection to the injection, Injection −3, one crankshaft revolution before the injection, Injection 0, for which the determined pressure is intended to form a basis.

Thus, prior to Injection 0 there is an Injection −1 immediately before Injection 0 where and an Injection −2 immediately before Injection −1 and the Injection −3 immediately before Injection −2. The crankshaft thus rotates 120 between each injection, i.e. TDC of each injection. As there are six cylinders there are of course an injection −4, an injection −5 and an injection −6, the injection −6 corresponding to the same injector as Injection 0.

Thus, although this pressure sampling is not the latest possible sample data, i.e. sample data in connection to Injection −1, it will provide a more accurate result than a pressure sampling performed in connection to Injection −1 and/or Injection −2 as explained with reference to FIG. 4. Furthermore the invention facilitates avoiding the problem of the fact that the average of the pressure sampling is repeatedly determined by means of an electronic control unit on a regular time basis, e.g. every 10 ms, which may occur on different times relative to injections and which thus may result in sample data acquired at Injection −1 for which the determined pressure is intended to form a basis not being calculated.

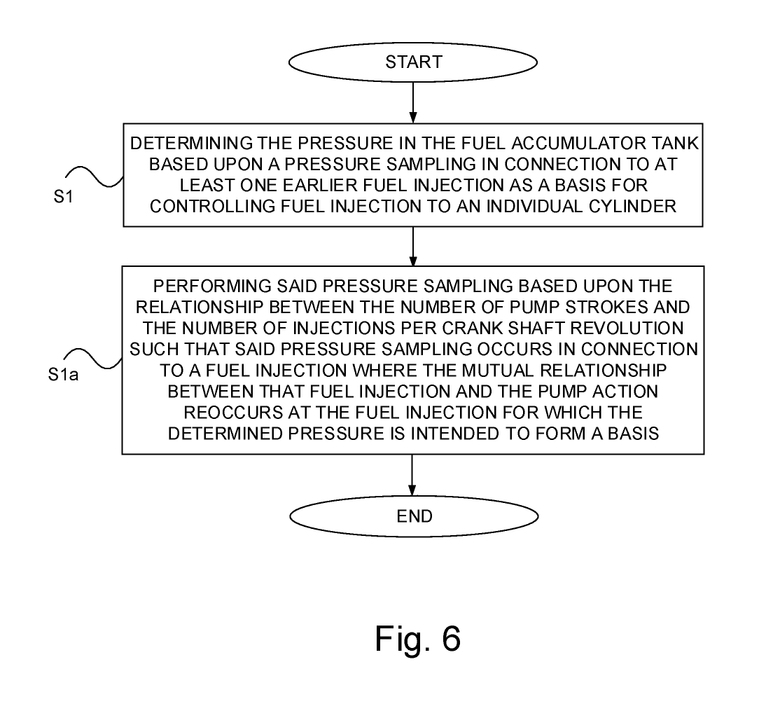

FIG. 6 schematically illustrates a method for determining pressure in a fuel accumulator tank of a multi cylinder internal combustion engine during engine operation according to an embodiment of the present invention.

Pressurized fuel is intended to be distributed from said accumulator tank to the cylinders by means of fuel injectors so as to rotate a crankshaft of the engine. A pump unit is provided for providing pressurized fuel to said accumulator tank by means of pump actions comprising pump strokes.

According to the embodiment the method for determining pressure in a fuel accumulator tank of a multi cylinder internal combustion engine during engine operation according to an embodiment of the present invention comprises a step S1. In this step the pressure in the fuel accumulator tank is determined based upon a pressure sampling in connection to at least one earlier fuel injection as a basis for controlling fuel injection to an individual cylinder.

According to the embodiment the method for determining pressure in a fuel accumulator tank of a multi cylinder internal combustion engine during engine operation according to an embodiment of the present invention comprises a step S1a. In this step said pressure sampling is performed based upon the relationship between the number of pump strokes and the number of injections per crank shaft revolution such that said pressure sampling occurs in connection to a fuel injection where the mutual relationship between that fuel injection and the pump action reoccurs at the fuel injection for which the determined pressure is intended to form a basis. The step S1a performing the pressure sampling is part of the step S1 of determining the pressure in the accumulator tank.

Thus the repetitive behavior of the relationship of the number of pump strokes and number of fuel injections is used for the pressure sampling so as to provide a more accurate pressure to be used as a basis for the fuel injection, i.e. as a basis for the amount of fuel to be injected and the on-time for the injector from which fuel is intended to be injected into an individual cylinder for combustion.

The pressure sampling is performed such that said pressure sampling occurs in connection to a fuel injection so that both the number of pump strokes and the number of fuel injections from the sampling to the fuel injection for which the determined pressure is intended to form a basis correspond to an integer value. For a six cylinder engine providing four pump strokes and three fuel injections per crankshaft revolution an integer value of both pump strokes and fuel injections occurs every crank shaft revolution, and although this pressure sampling not being the latest possible sample data, it will provide a more accurate result than a pressure sampling performed in connection to e.g. the injection immediately before the injection for which the determined pressure is intended to form a basis, i.e. one third of a revolution. Furthermore the invention facilitates avoiding the problem of the fact that the average of the pressure sampling is repeatedly determined by means of an electronic control unit on a regular time basis, e.g. every 10 ms, which may occur on different times relative to injections and pump strokes and which thus may result in data acquired immediately before the injection for which the determined pressure is intended to form a basis not being calculated.

By thus performing the pressure sampling during steady state operation of the engine based upon said relationship between the number of pump strokes and the number of injections per crank shaft revolution the pressure sampling occurs in connection to an earlier fuel injection where the behavior of the pressure in the fuel accumulator tank is expected to essentially reoccur at the fuel injection for which the determined pressure is intended to form a basis. Fuel injection and pump stroke/pump action are related to the engine speed so that the pressure behavior at that fuel injection when the relationship between pump stroke and fuel injection is repeated will be essentially the same during steady state operation.

Thus, the fact the pressure behavior shows a pattern that is repeated based upon the relationship of number of pump strokes and number of fuel injections during rotation of the crankshaft, facilitates providing a result of the pressure from such pressure sampling that will to a very accurate extent be repeated in connection to the injection for which the pressure is predicted. This thus facilitates improved control of engine operation, comprising more efficient engine operation, reduced emissions, decreased losses and the like.

For steady state engine operation and low speeds where losses and low engine operation efficiency due to inaccuracy relating to fuel injection becomes more apparent the invention is particularly useful in that it, by more accurately predicting the pressure in the accumulator tank/common rail, facilitates more accurate fuel injection with regard to amount of fuel and on-time for fuel injection, which results in improved engine efficiency and reduction in losses.

By thus performing the pressure sampling based upon said relationship between the number of pump strokes and the number of injections per crank shaft revolution so that sampling is performed in connection to a fuel injection with a relationship of fuel injection and pump stroke/pump action that is repeated at the fuel injection for which the determined pressure is intended to form a basis an accurate determination will be obtained independently of the relationship of the number of pump strokes and number of fuel injections per crankshaft operation and independently of if there is no synchronization with regard to crankshaft degree between the pump strokes and the fuel injections, which is common, or whether they are synchronized, and independently of how the pump unit is operated, i.e. independently of whether the pump unit is operated by means of the engine/crankshaft/camshaft operation or electrically operated.

As the pressure behavior is repeated possible errors would also be repeated and from a control system perspective it is easier to control and adjust an error that is repeating than an error which shows a stochastic behavior. By thus basing the pressure sampling on the relationship between the number of pump strokes and number of injections per crankshaft revolution such that the reoccurrence of the relationship and thus behavior is used the error in determining the pressure is reduced, but furthermore the possible error is moved from a stochastic behavior to behaving in the same way. Thus, the invention also improves the possibility of compensating for possible errors.

If the respective fuel injection to an individual cylinder during engine operation is a fuel injection event in a multiple injection strategy for fuel injection into an individual cylinder pressure sampling may be performed in connection to one or more of the multiple injections to an individual cylinder. Thus, when a fuel injection in connection to which pressure sampling is performed is a fuel injection event in a multiple injection strategy for fuel injection into an individual cylinder involving pilot injection, main injection and post injection, pressure sampling may be performed in connection to the pilot injection and/or the main injection and/or the post injection.

When a fuel injection in connection to which pressure sampling is performed is a fuel injection event in a multiple injection strategy for fuel injection into an individual cylinder involving pilot injection, main injection and post injection the pressure behavior will reoccur where the mutual relationship between that fuel injection and the pump action reoccurs for each of the pilot injection, main injection and post injection.

According to an embodiment of the method the step of performing said pressure sampling further comprises the step of performing said pressure sampling such that said pressure sampling occurs in connection to a fuel injection where the fuel injection with that same fuel injector reoccurs at the fuel injection for which the determined pressure is intended to form a basis.

By, in addition to utilizing the reoccurrence of the behavior of the pump stroke/pump action in connection to the fuel injections where pressure sampling is performed, performing the fuel sampling in connection to the fuel injection of the same injector, an even more accurate determination of the pressure in the accumulator tank may be facilitated during a steady state engine operation. This is due to the fact that each injector has its own tolerances and therefore may cause a slight difference in the pressure behavior, whereas the same injector will provide the same behavior. Thus, even if the result of a pressure sampling using the same injector is based on older data, it may during a steady state engine operation provide a more accurate determination of the pressure forming a basis for the upcoming fuel injection. According to an embodiment sampling may be performed such that both data for pressure sampling in connection to the same injector with reoccurrence of the pump action behavior and newer data for pressure sampling with reoccurrence of the pump action behavior are used as a basis the fuel injection. For a six cylinder engine providing four pump strokes and three fuel injections per crankshaft revolution the same injector reoccurs every second crankshaft revolution.

According to an embodiment of the method, for a six cylinder engine providing four pump strokes and three fuel injections per crankshaft revolution, the pressure sampling is performed such that said pressure sampling occurs in connection to a fuel injection one revolution and/or two revolutions before the fuel injection for which the determined pressure is intended to form a basis.

According to an embodiment of the method the step S1a of performing pressure sampling in connection to a fuel injection comprises performing pressure sampling before start of injection and after end of injection, wherein the number of samples are chosen with regard to the fluid hammer due to and end of injection. Preferably pressure sampling is performed before the start of the fuel injection and after the end of the fuel injection.

When a fuel injection in connection to which pressure sampling is performed is a fuel injection event in a multiple injection strategy for fuel injection into an individual cylinder involving pilot injection, main injection and post injection, pressure sampling is performed such that if pressure sampling is performed in connection to the pilot injection it is performed before start of pilot injection and after end of pilot injection, if pressure sampling is performed in connection to the main injection it is performed before start of main injection and after end of main injection, and if pressure sampling is performed in connection to the post injection it is performed before start of post injection and after end of post injection.

By performing pressure sampling before the start of the fuel injection and after the end of the fuel injection a good basis for determining the pressure by means of taking the average of the samples of said pressure sampling is obtained. An average value of the samples of the pressure sampling before start of fuel injection is calculated and another average value of the samples of the pressure sampling after end of fuel injection is calculated. More specifically a good basis for determining the average pressure from start of injection to end of injection by means of taking the average of the samples of said pressure sampling is facilitated. As mentioned below the start of injection and end of injection are according to an embodiment the mechanical/hydraulic start of injection and end of injection. The start of injection and end of injection could also be the electrical start of injection and end of injection. By choosing the number of samples of the pressure sampling with regard to the fluid hammer, i.e. the wave of the fuel caused by opening and closing the valves of the fuel injector for starting and ending the fuel injection, the oscillations of the period of the fluid hammer can be cancelled out by taking the average of those samples. Thus, samples corresponding to the period of the fluid hammer are chosen. The oscillation period depends on the accumulator geometry, in particular the length of the fluid column where the wave propagates, and the speed of sound in the medium depending on accumulator pressure, i.e. rail pressure, and fuel properties. The number of samples is according to an embodiment in the range of 1-50, e.g. 3-30, samples before start of injection and in the range of 1-50, e.g. 3-30 samples after end of injection The number of samples is according to an embodiment for a certain fuel injection system 24 samples before start of injection and 24 samples after end of injection, which is e.g. applicable to a six cylinder engine providing three injections and four pump strokes per crankshaft revolution. Sampling in this way is chosen as it is assumed that the fluid hammer measured at the location of the pressure sensor unit is different from what is actually happening in connection to the injector. Therefore, the effect of the fluid hammer is eliminated by averaging it. Ideally, this average should well represent the average pressure at the injector.

According to an embodiment of the method start of injection before which pressure sampling is performed is the mechanical start of injection and wherein end of injection after which pressure sampling is performed is the mechanical end of injection. By thus basing the pressure sampling on the mechanical, e.g. hydraulic, start/end of injection instead of the electrical start/end of injection a more accurate pressure sampling is obtained as the mechanical start and end of injection may be accurately predicted which facilitates determining a more accurate average pressure during injection by sampling of the pressure immediately before mechanical start of injection and immediately after start of injection. By thus basing the pressure sampling on the mechanical, e.g. hydraulic, start/end of injection instead of the electrical start/end of injection the physics of the pressure behavior is better captured and the average of the pressure samples should better represent the actual mean accumulator pressure, i.e. rail pressure, before/after injection.

According to an embodiment of the method the step S1a of performing pressure sampling based upon the relationship between the number of pump strokes and the number of injections per crank shaft revolution is performed under steady state operation, the method further comprising the step of changing the performance of pressure sampling such that pressure sampling is performed at the fuel injection closest to the fuel injection of fuel injections for which the determined pressure is intended to form a basis if the engine operation changes from steady state operation to operation involving rapid changes of pressure in the fuel accumulator tank. Hereby the pressure sampling is controlled in an efficient way such that the determined pressure is the most accurate possible both during steady state engine operation and engine operation involving engine speed changes.

The method and the method steps described above with reference to FIG. 5 are according to an embodiment performed with the system I according to FIG. 2.

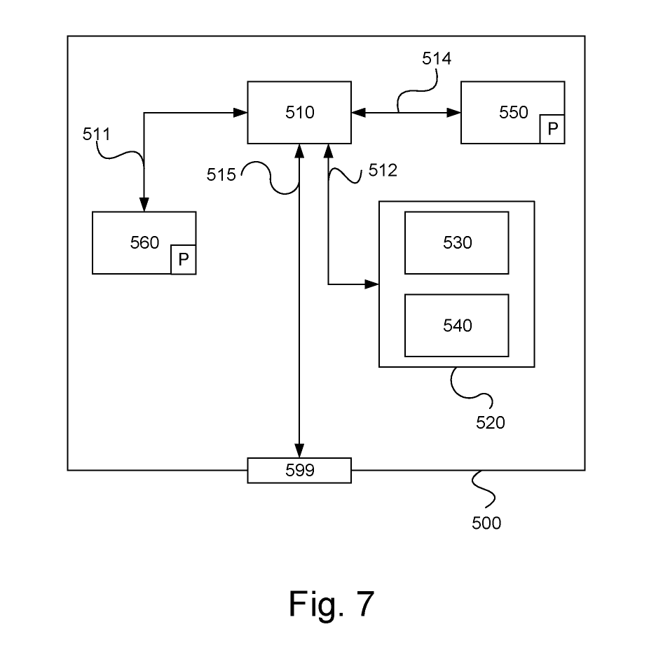

With reference to FIG. 7, a diagram of an apparatus 500 is shown. The system I described with reference to FIG. 2 may according to an embodiment comprise apparatus 500. Apparatus 500 comprises a non-volatile memory 520, a data processing device 510 and a read/write memory 550. Non-volatile memory 520 has a first memory portion 530 wherein a computer program, such as an operating system, is stored for controlling the function of apparatus 500. Further, apparatus 500 comprises a bus controller, a serial communication port, I/O-means, an A/D-converter, a time date entry and transmission unit, an event counter and an interrupt controller (not shown). Non-volatile memory 520 also has a second memory portion 540.

A computer program P is provided comprising routines for determining pressure in a fuel accumulator tank of a multi cylinder internal combustion engine during engine operation. The program P comprises routines for determining the pressure in the fuel accumulator tank based upon a pressure sampling in connection to at least one earlier fuel injection as a basis for controlling fuel injection to an individual cylinder. The program P comprises routines for performing said pressure sampling based upon the relationship between the number of pump strokes and the number of injections per crank shaft revolution such that said pressure sampling occurs in connection to a fuel injection where the mutual relationship between that fuel injection and the pump action reoccurs at the fuel injection for which the determined pressure is intended to form a basis. The program P comprises routines for performing said pressure sampling such that said pressure sampling occurs in connection to a fuel injection where the fuel injection with that same fuel injector reoccurs at the fuel injection for which the determined pressure is intended to form a basis. The program P comprises routines for, for a six cylinder engine providing four pump strokes and three fuel injections per crankshaft revolution, performing the pressure sampling such that said pressure sampling occurs in connection to a fuel injection one revolution and/or two revolutions before the fuel injection for which the determined pressure is intended to form a basis. The program P comprises routines for performing pressure sampling before start of injection and after end of injection, wherein the number of samples are chosen with regard to the fluid hammer due to and end of injection. The start of injection before which pressure sampling is performed is the mechanical start of injection and end of injection after which pressure sampling is performed is the mechanical end of injection. The program P comprises routines for performing pressure sampling based upon the relationship between the number of pump strokes and the number of injections per crank shaft revolution under steady state operation, and routines for changing the performance of pressure sampling such that pressure sampling is performed at the fuel injection closest to the fuel injection for which the determined pressure is intended to form a basis if the engine operation changes from steady state operation to operation involving rapid changes of pressure in the fuel accumulator tank. The computer program P may be stored in an executable manner or in a compressed condition in a separate memory 560 and/or in read/write memory 550.

When it is stated that data processing device 510 performs a certain function it should be understood that data processing device 510 performs a certain part of the program which is stored in separate memory 560, or a certain part of the program which is stored in read/write memory 550.

Data processing device 510 may communicate with a data communications port 599 by means of a data bus 515. Non-volatile memory 520 is adapted for communication with data processing device 510 via a data bus 512. Separate memory 560 is adapted for communication with data processing device 510 via a data bus 511. Read/write memory 550 is adapted for communication with data processing device 510 via a data bus 514. To the data communications port 599 e.g. the links connected to the control units 100 may be connected.

When data is received on data port 599 it is temporarily stored in second memory portion 540. When the received input data has been temporarily stored, data processing device 510 is set up to perform execution of code in a manner described above. The signals received on data port 599 can be used by apparatus 500 for determining the pressure in the fuel accumulator tank based upon a pressure sampling in connection to at least one earlier fuel injection as a basis for controlling fuel injection to an individual cylinder. The signals received on data port 599 can be used by apparatus 500 for performing said pressure sampling based upon the relationship between the number of pump strokes and the number of injections per crank shaft revolution such that said pressure sampling occurs in connection to a fuel injection where the mutual relationship between that fuel injection and the pump action reoccurs at the fuel injection for which the determined pressure is intended to form a basis. The signals received on data port 599 can be used by apparatus 500 for performing said pressure sampling such that said pressure sampling occurs in connection to a fuel injection where the fuel injection with that same fuel injector reoccurs at the fuel injection for which the determined pressure is intended to form a basis. The signals received on data port 599 can be used by apparatus 500 for, for a six cylinder engine providing four pump strokes and three fuel injections per crankshaft revolution, performing the pressure sampling such that said pressure sampling occurs in connection to a fuel injection one revolution and/or two revolutions before the fuel injection for which the determined pressure is intended to form a basis. The signals received on data port 599 can be used by apparatus 500 for performing pressure sampling before start of injection and after end of injection, wherein the number of samples are chosen with regard to the fluid hammer due to and end of injection. The start of injection before which pressure sampling is performed is the mechanical start of injection and end of injection after which pressure sampling is performed is the mechanical end of injection. The signals received on data port 599 can be used by apparatus 500 for performing pressure sampling based upon the relationship between the number of pump strokes and the number of injections per crank shaft revolution under steady state operation, and be used by apparatus 500 for changing the performance of pressure sampling such that pressure sampling is performed at the fuel injection closest to the fuel injection for which the determined pressure is intended to form a basis if the engine operation changes from steady state operation to operation involving rapid changes of pressure in the fuel accumulator tank.

Parts of the methods described herein can be performed by apparatus 500 by means of data processing device 510 running the program stored in separate memory 560 or read/write memory 550. When apparatus 500 runs the program, parts of the methods described herein are executed.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated.

1. A method for determining pressure in a fuel accumulator tank of a multi cylinder internal combustion engine during engine operation, pressurized fuel being intended to be distributed from said accumulator tank to the cylinders by means of fuel injectors so as to rotate a crankshaft of the engine, a pump unit being provided for providing pressurized fuel to said accumulator tank by means of pump actions comprising pump strokes, the method comprising:
performing pressure sampling of pressure in the fuel accumulator tank based upon a relationship between the number of pump strokes and a number of injections per crank shaft revolution such that said pressure sampling occurs in connection to a fuel injection where a mutual relationship between that fuel injection and the pump action reoccurs at a fuel injection for which a determined pressure is to be determined; and
determining a pressure in the fuel accumulator tank based upon the pressure sampling in connection to at least one earlier fuel injection, as a basis for controlling fuel injection to an individual cylinder.

2. A method according to claim 1, wherein the step of performing said pressure sampling further comprises the step of performing said pressure sampling such that said pressure sampling occurs in connection to a fuel injection where the fuel injection with that same fuel injector reoccurs at the fuel injection for which the determined pressure is intended to form a basis.

3. A method according to claim 1, wherein, for a six cylinder engine providing four pump strokes and three fuel injections per crankshaft revolution, the pressure sampling is performed such that said pressure sampling occurs in connection to a fuel injection one revolution and/or two revolutions before the fuel injection for which the determined pressure is intended to form a basis.

4. A method according to claim 1, wherein the step of performing pressure sampling in connection to a fuel injection comprises performing pressure sampling before start of injection and after end of injection, wherein the number of samples are chosen with regard to a fluid hammer due to end of injection.

5. A method according to claim 4, wherein start of injection before which pressure sampling is performed is a mechanical start of injection and wherein end of injection after which pressure sampling is performed is a mechanical end of injection.

6. A method according to claim 1, wherein the step of performing pressure sampling based upon the relationship between the number of pump strokes and the number of injections per crank shaft revolution is performed under steady state operation, the method further comprising the step of changing a performance of pressure sampling such that pressure sampling is performed at a fuel injection or fuel injections closest to the fuel injection for which the determined pressure is intended to form a basis, if the engine operation changes from steady state operation to operation involving rapid changes of pressure in the fuel accumulator tank.

7. A system for determining pressure in a fuel accumulator tank of a multi cylinder internal combustion engine during engine operation, pressurized fuel being intended to be distributed from said accumulator tank to the cylinders by means of fuel injectors so as to rotate a crankshaft of the engine, a pump unit being provided for providing pressurized fuel to said accumulator tank by means of pump actions comprising pump strokes, the system comprising:
means for performing pressure sampling of pressure in the fuel accumulator tank based upon a relationship between the number of pump strokes and a number of injections per crank shaft revolution such that said pressure sampling occurs in connection to a fuel injection where a mutual relationship between that fuel injection and the pump action reoccurs at a fuel injection for which a determined pressure is to be determined; and
means for determining a pressure in the fuel accumulator tank based upon the pressure sampling in connection to at least one earlier fuel injection, as a basis for controlling fuel injection to an individual cylinder.

8. A system according to claim 7, wherein the means for performing said pressure sampling further comprises means for performing said pressure sampling such that said pressure sampling occurs in connection to a fuel injection where the fuel injection with that same fuel injector reoccurs at the fuel injection for which the determined pressure is intended to form a basis.

9. A system according to claim 7, wherein, for a six cylinder engine providing four pump strokes and three fuel injections per crankshaft revolution, said pressure sampling is arranged to be performed such that said pressure sampling occurs in connection to a fuel injection one revolution and/or two revolutions before the fuel injection for which the determined pressure is intended to form a basis.

10. A system according to claim 7, wherein the means for performing pressure sampling in connection to a fuel injection comprises means for performing pressure sampling before start of injection and after end of injection, wherein the number of samples are chosen with regard to a fluid hammer due to end of injection.

11. A system according to claim 10, wherein start of injection before which pressure sampling is arranged to be performed is a mechanical start of injection and wherein end of injection after which pressure sampling is arranged to be performed is a mechanical end of injection.

12. A system according to claim 7 comprising:
means for determining engine operation status, wherein the means for performing pressure sampling based upon the relationship between the number of pump strokes and the number of injections per crank shaft revolution is arranged to be performed under steady state engine operation; and
means for changing a performance of pressure sampling such that pressure sampling is performed at a fuel injection or fuel injections closest to the fuel injection for which the determined pressure is intended to form a basis if the engine operation changes from steady state engine operation to operation involving rapid changes of pressure in the fuel accumulator tank.

13. A vehicle comprising a system for determining pressure in a fuel accumulator tank of a multi cylinder internal combustion engine during engine operation, pressurized fuel being intended to be distributed from said accumulator tank to the cylinders by means of fuel injectors so as to rotate a crankshaft of the engine, a pump unit being provided for providing pressurized fuel to said accumulator tank by means of pump actions comprising pump strokes, the system comprising:
means for performing pressure sampling of pressure in the fuel accumulator tank based upon a relationship between the number of pump strokes and a number of injections per crank shaft revolution such that said pressure sampling occurs in connection to a fuel injection where a mutual relationship between that fuel injection and the pump action reoccurs at a fuel injection for which a determined pressure is to be determined; and
means for determining a pressure in the fuel accumulator tank based upon the pressure sampling in connection to at least one earlier fuel injection, as a basis for controlling fuel injection to an individual cylinder.

14. (canceled)

15. (canceled)

16. A vehicle according to claim 13, wherein the means for performing said pressure sampling further comprises means for performing said pressure sampling such that said pressure sampling occurs in connection to a fuel injection where the fuel injection with that same fuel injector reoccurs at the fuel injection for which the determined pressure is intended to form a basis.

17. A vehicle according to claim 13, wherein, for a six cylinder engine providing four pump strokes and three fuel injections per crankshaft revolution, said pressure sampling is arranged to be performed such that said pressure sampling occurs in connection to a fuel injection one revolution and/or two revolutions before the fuel injection for which the determined pressure is intended to form a basis.

18. A vehicle according to claim 13, wherein the means for performing pressure sampling in connection to a fuel injection comprises means for performing pressure sampling before start of injection and after end of injection, wherein the number of samples are chosen with regard to a fluid hammer due to end of injection.

19. A computer program product comprising computer program code stored on a non-transitory computer-readable medium, said computer program product for determining pressure in a fuel accumulator tank of a multi cylinder internal combustion engine during engine operation, pressurized fuel being intended to be distributed from said accumulator tank to the cylinders by means of fuel injectors so as to rotate a crankshaft of the engine, a pump unit being provided for providing pressurized fuel to said accumulator tank by means of pump actions comprising pump strokes, said computer program product comprising computer instructions to cause one or more computer processors to perform the following operations:
performing pressure sampling of pressure in the fuel accumulator tank based upon a relationship between the number of pump strokes and a number of injections per crank shaft revolution such that said pressure sampling occurs in connection to a fuel injection where a mutual relationship between that fuel injection and the pump action reoccurs at a fuel injection for which a determined pressure is to be determined; and
determining a pressure in the fuel accumulator tank based upon the pressure sampling in connection to at least one earlier fuel injection, as a basis for controlling fuel injection to an individual cylinder.

20. A computer program product according to claim 19, wherein performing said pressure sampling further comprises performing said pressure sampling such that said pressure sampling occurs in connection to a fuel injection where the fuel injection with that same fuel injector reoccurs at the fuel injection for which the determined pressure is intended to form a basis.

21. A computer program product according to claim 19, wherein, for a six cylinder engine providing four pump strokes and three fuel injections per crankshaft revolution, the pressure sampling is performed such that said pressure sampling occurs in connection to a fuel injection one revolution and/or two revolutions before the fuel injection for which the determined pressure is intended to form a basis.

22. A computer program product according to claim 19, wherein performing pressure sampling in connection to a fuel injection comprises performing pressure sampling before start of injection and after end of injection, wherein the number of samples are chosen with regard to a fluid hammer due to end of injection.
